(19) United States
(12) Patent Application Publication
(10) Pub. No.: US 2010/0280681 A1
(43) Pub. Date: Nov. 4, 2010

(54) VEHICLE-MOUNTED ELECTRONIC CONTROLLER

(75) Inventor: Kenichi Horikawa, Yokkaichi-shi (JP)

Correspondence Address: OLIFF & BERRIDGE, PLC, P.O. BOX 320850, ALEXANDRIA, VA, 22320-4850, US

(73) Assignees: Autonetworks Technologies, Ltd., Yokkaichi-shi (JP); Sumitomo Wiring Systems, Ltd., Yokkaichi-shi (JP); Sumitomo Electric Industries, Ltd., Osaka-shi (JP)

(21) Appl. No.: 12/810,086

(22) PCT Filed: Feb. 16, 2009
(86) PCT No.: PCT/JP2009/052496

§ 371 Date: Jun. 22, 2010

(30) Foreign Application Priority Data
Feb. 22, 2008 (JP) 2008 042109

(51) Int. Cl. G06F 7/00

(52) U.S. Cl. 701/1

(57) ABSTRACT

A vehicle-mounted electronic controller which executes applications by using the data acquired from the same vehicle-mounted device and in which the plurality of applications with different execution periods are installed comprises a storage section for storing the data acquired from the vehicle-mounted device and elapsed time(tb) from the time of acquiring the data and a processing section for comparing the elapsed time(tb) from the data acquisition in the storage section with allowable elapsed time(tb) the time of acquiring the data till the time of executing the applications by using the data, executing the applications by using the data when the elapsed time(tb) is within the allowable elapsed time(ta), and making a request for the transmission of the data to the vehicle-mounted device to acquire the latest data when the elapsed time(tb) exceeds the allowable elapsed time(ta).

### TECHNICAL FIELD

The present invention relates to an electronic control unit to be mounted on a car. More particularly the present invention is intended to prevent a plurality of applications mounted on the electronic control unit from obtaining duplicate information when the applications use information by obtaining it from the same device mounted on the car.

### BACKGROUND ART

In recent years, as cars have come to have high function and performance, the number of electrical devices and control systems mounted on a car has increased, and the number of electronic control units for operating the electrical devices and the control systems has rapidly increased. Therefore there have occurred a problem of disposing spaces in which the electrical devices and the electronic control units are disposed and a problem of an increase in the weight of a vehicle. Thus the control of a plurality of the electrical devices and the control systems by one electronic control unit is made to decrease the number of the electronic control units.

For example, in Japanese Patent Applications Laid-Open No. 2007-90951, the construction in which the path guide system and the driving skill evaluation system are operated by one electronic control unit is disclosed. The electronic control unit has an application for each system. A plurality of the applications is executed in the cycle optimum for each system.

In the electronic control unit, there is a case in which the same data is used by a plurality of the applications. For example, the electronic control unit is connected to the car-speed sensor, and the car-speed information is used by the application of the path guide system and that of the driving skill evaluation system. At this time, each application accesses the car-speed sensor individually as necessary and obtains the car-speed information outputted from the car-speed sensor.

In the case where the applications obtain information individually from the devices, mounted on the car, such as the car-speed sensor, there occurs a state in which the applications access the device mounted on the car many times in a short period of time in dependence on timing when the applications obtain the information.

Each application does not necessarily have to always obtain latest information, but there is a case in which information obtained by a certain application can be used by other applications.

Therefore in the case where the applications obtain information individually from the device mounted on the car, there occurs a problem that a microcomputer resource is wastefully used.

Further when A/D conversion is performed in obtaining information from the device mounted on the car, it takes time to perform the A/D conversion, which leads to deterioration of response performance.

Patent document 1: Japanese Patent Applications Laid-Open No. 2007-90951

### DISCLOSURE OF THE INVENTION

### Problem to be Solved by the Invention

The present invention has been made in view of the above-described problem. It is an object of the present invention to prevent a plurality of applications mounted on an electronic control unit from obtaining duplicate information when the applications use information by obtaining it from the same device mounted on the car and prevent a microcomputer resource from being wastefully used.

### Means for Solving the Problem

To solve the above-described problem, the present invention provides an electronic control unit to be mounted on a car executing a plurality of applications, having different execution cycles, which are mounted on the electronic control unit by using data obtained from the same device mounted on the car.

The electronic control unit has a storing part storing data obtained from the device mounted on the car and an elapsed period of time from a time when the data is obtained; and
a processing part which compares the elapsed period of time of the data stored by the storing part with an allowed elapsed period of time from the time when the data is obtained till a time when each application is executed by using the data, thus executing each of the applications by using the data when the elapsed period of time falls within the allowed elapsed period of time and requesting the device mounted on the car to send data thereto to obtain latest data when the elapsed period of time exceeds the allowed elapsed period of time.

When each application obtains data from the device mounted on the car, the storing part stores the data and the elapsed period of time from the time when the data is obtained. The execution cycles of the applications are different from one another. Degrees of newness (freshness) of data required by the applications are also different from one another. Therefore there is a case in which data obtained by an application from the device mounted on the car and stored by the storing part can be used by other applications as new data.

Therefore the allowed elapsed period of time showing the degree of newness of data at which the data can be used is set for each application. In obtaining data, when data indicating that the elapsed period of time from the time when the data is obtained falls within the allowed elapsed period of time is present in the storing part, each application is executed by using the data stored by the storing part. On the other hand, when the elapsed period of time of data stored by the storing part exceeds the allowed elapsed period of time, each application is executed by obtaining the data from the device mounted on the car.

As described above, when the elapsed period of time from the time when the data stored by the storing part is obtained falls within the allowed elapsed period of time set for each of the applications, the applications obtain data not from the device mounted on the car but from the storing part. Thereby the applications are capable of obtaining data at a high speed, and the response performance can be improved.

Further it is possible to prevent the electronic control unit from accessing to the device mounted on the car many times in a short period of time to obtain data and a microcomputer resource from being wastefully used.

The elapsed period of time stored by the storing part is updated every predetermined period of time.

The predetermined period of time is favorably not less than 0.05 msec nor more than 100 msec and more favorably not less than 0.5 msec nor more than 10 msec. 0011 It is preferable that the processing part has a platform which accesses the device mounted on the car to obtain data and sends the data to a plurality of the applications at requests thereof.

When one application sends a request to the platform to send data of the device mounted on the car thereto, by actuating a corresponding API and accessing the device mounted on the car, the platform obtains data and passes the data to the application which has requested to obtain the data.

It is preferable that a plurality of the applications includes any one of a headlight control application, a car interior light control application, a wiper control application, and an engine control application.

When the electronic control unit has applications such as the car interior light control application, the wiper control application which have a long execution cycle and a low degree of demand for high responsiveness and applications such as the headlight control application, the engine control application which have a short execution cycle and a high degree of demand for high responsiveness mounted thereon, the application which has the long execution cycle and the low degree of demand for high responsiveness is capable of using data obtained by the application which has the short execution cycle and the high degree of demand for high responsiveness. Therefore the present invention can be preferably used.

### EFFECT OF THE INVENTION

As described above, according to the electronic control unit of the present invention, when the elapsed period of time from the time when the data stored by the storing part is obtained falls within the allowed elapsed period of time set for each of the applications, the applications obtain data not from the device mounted on the car but from the storing part. Thereby the applications are capable of obtaining data at a high speed.

Further it is possible to prevent the electronic control unit from accessing to the device mounted on the car many times in a short period of time to obtain data and the microcomputer resource from being wastefully used.

### BRIEF DESCRIPTION OF THE DRAWINGS

FIG. 1 is an overall schematic block diagram showing an embodiment of an electronic control unit of the present invention to be mounted on a car.

FIG. 2 is a block diagram of software of the electronic control unit to be mounted on a car.

FIG. 3 shows an example of a table.

FIG. 4 is a block diagram of hardware of the electronic control unit to be mounted on a car.

FIG. 5 is a flowchart showing the operation of a headlight control application.

FIG. 6 is a flowchart showing the operation of obtaining a data value of an illuminance sensor.

FIG. 7 is a flowchart showing the operation of an interior light control application.

### EXPLANATION OF REFERENCE SYMBOLS AND NUMERALS

10: electronic control unit
11: illuminance sensor
12: headlight
13: engine
14: light switch
15: interior light
16: door opening/closing sensor
21: headlight control application
22: interior light control application
23: platform
24: API library
T: table
tb: elapsed period of time
ta: allowed elapsed period of time

### BEST MODE FOR CARRYING OUT THE INVENTION

The embodiments of the present invention are described below with reference to the drawings.

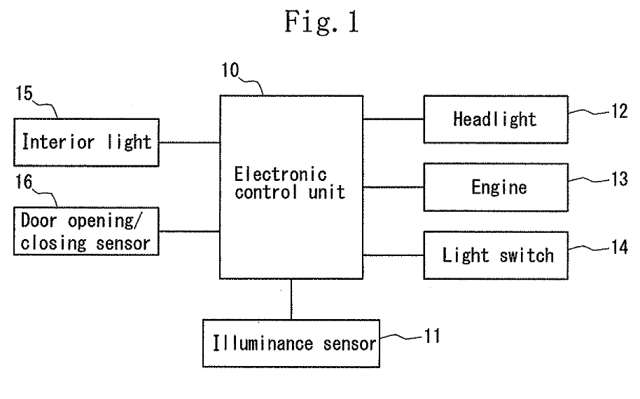

FIGS. 1 through 7 shows an embodiment of the present invention.

An electronic control unit 10 of the present invention controls a light system mounted on a car.

As shown in FIG. 1, the electronic control unit 10 is connected to a illuminance sensor 11 measuring a car-exterior illuminance and to a headlight 12, an engine 13, and a light switch 14, thus controlling the headlight 12 by turning on or off the headlight 12 by using a data value of the illuminance sensor 11 when the engine has started and the light switch 14 is placed in an automatic mode.

The electronic control unit 10 is also connected to an interior light 15 and a door opening/closing sensor 16. The electronic control unit 10 controls on or off of the interior light 15 by using a data value of the illuminance sensor 11 when any one of doors of the car is open.

The execution cycle of the headlight control and that of the interior light control are different from each other. The execution cycle of the headlight control and that of the interior light control are 10 msec and 20 msec respectively.

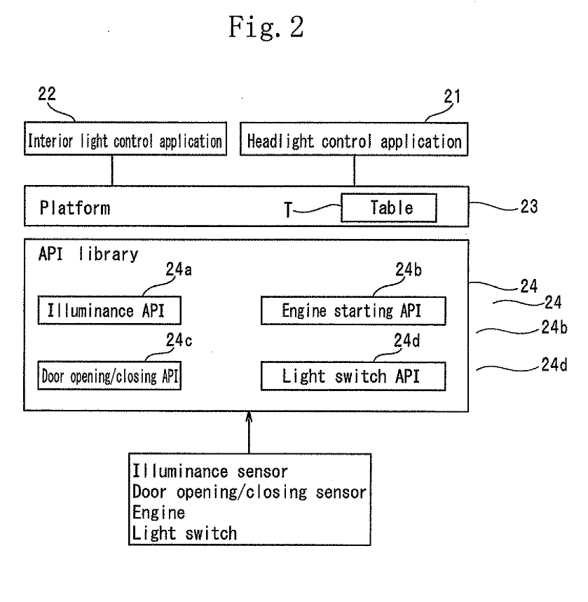

FIG. 2 shows the block diagram of software for executing the headlight control and the interior light control to be executed by the electronic control unit 10.

The electronic control unit 10 has software of a headlight control application 21 and an interior light control application 22 as applications for the headlight control and the interior light control.

The electronic control unit has a platform 23 which is a manager layer responding to a request sent thereto from each application. The platform 23 includes various managers (not shown) for collecting the data value of the illuminance sensor 11.

The headlight control application 21 sends a request to the platform 23 to detect whether the engine has started and the light switch 14 is in an automatic mode.

When the engine has started and the light switch 14 is in the automatic mode, the headlight control application 21 sends a request for obtaining the data value of the illuminance sensor 11 to the platform 23. At this time, the headlight control application 21 also sends a request for obtaining an allowed elapsed period of time ta as an argument to the platform 23. The headlight control application 21 turns on or off the headlight 12 by using the received data value of the illuminance sensor 11.

The interior light control application 22 sends a request to the platform 23 to detect whether any one of the doors of the car is open.

When any one of the doors is open, the interior light control application 22 sends a request for obtaining the data value of the illuminance sensor 11 to the platform 23. At this time, the interior light control application 22 also sends the allowed elapsed period of time ta as an argument to the platform 23. The interior light control application 22 turns on or off the interior light 15 by using the received data value of the illuminance sensor 11.

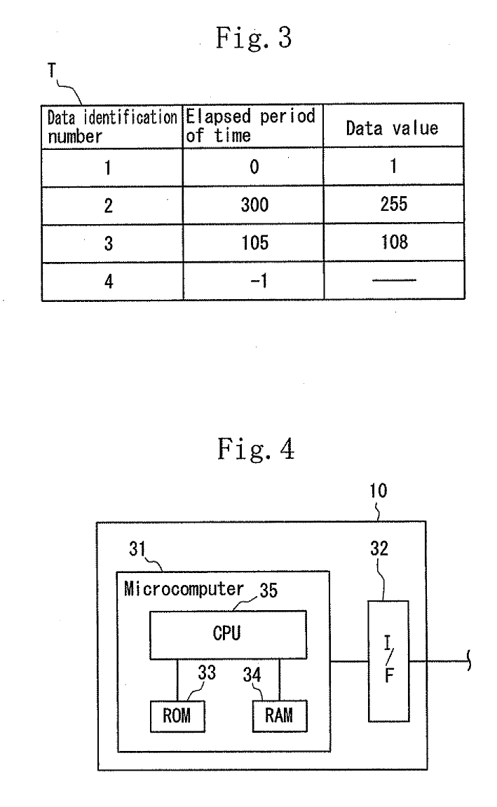

The platform 23 stores the data value of the illuminance sensor 11 the headlight control application 21 and the interior light control application 22 requested and obtained in a storing region in the form of a table T. FIG. 3 shows an example of the table T. The table T is composed of data identification numbers, elapsed period of times tb from a time when data is obtained, and data values.

Each time the platform 23 obtains the data value sent from the illuminance sensor 11, the platform 23 sequentially stores data values in regions in the order from a region having a smaller data identification number to a region having a larger data identification number.

The elapsed period of time tb from the data-obtained time is so set that the time when data is obtained from the illuminance sensor 11 and stored in the table T is set to “0” and that the elapsed period of time tb is updated every 0.1 msec by the addition of “1”. For example, a case where the elapsed period of time tb from the data-obtained time is “300” indicates the elapse of 300 msec after the platform 23 obtains the data.

In FIG. 3, the data identification number of “4” has a negative elapsed period of time tb, which indicates that a region having the data identification number of “4” has not obtained data after actuation of the electronic control unit 10.

The data value is measured by the illuminance sensor 11 and indicated by a value obtained by A/D conversion.

The platform 23 receives the request for obtaining the data of the illuminance sensor 11 and the allowed elapsed period of time ta from the headlight control application 21 or the interior light control application 22. When a data having a value indicating that the elapsed period of time tb from the time when the data of the illuminance sensor 11 is obtained falls within the allowed elapsed period of time ta is present in the table T, the platform 23 passes the data value of the table T to the headlight control application 21 or the interior light control application 22. When only data exceeding the allowed elapsed period of time ta is present in the table T, the platform 23 obtains data from the illuminance sensor 11.

The electronic control unit 10 has an API library 24 including an API (Application Program Interface) group for processing requests from the applications. When a request is made from any one of the applications, the platform 23 receives the request and actuates the API of the API library 24 according to the request. The API performs an operation according to the request and creates a response to the request, thus passing the response to the platform 23.

The API library includes an illuminance API 24a, an engine starting API 24b, a door opening/closing API 24c, and a light switch API 24d.

The illuminance API 24a obtains car-exterior illuminance data from the illuminance sensor 11. The engine starting API 24b detects whether the engine 13 has started. The door opening/closing API 24c detects whether the door of the car has opened or closed. The light switch API 24d detects whether the headlight 12 has been placed in an automatic mode.

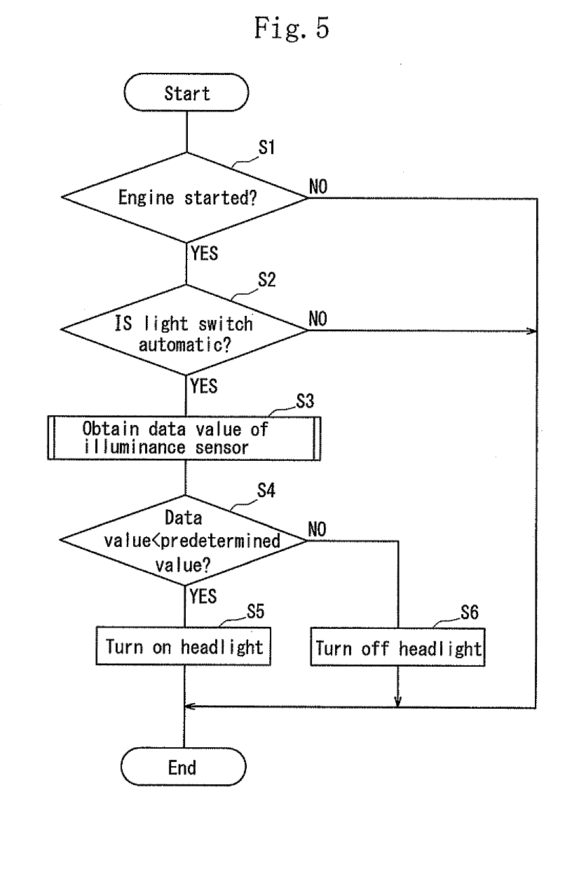

FIG. 4 shows the construction of the hardware of the electronic control unit 10. The hardware is composed of a microcomputer 31 and an I/F (interface) 32. Although not shown in FIG. 4, the I/F 32 is connected to the door opening/closing sensor 16, the illuminance sensor 11, the light switch 14, the engine 13, the interior light 15, and the headlight 12.

The applications are stored by a ROM 33 of the microcomputer 31 constructing a storing part. The table T is stored by a RAM 34 of the microcomputer 31. The operation of the applications and the platform 23 are executed by a CPU 35 of the microcomputer 31 constructing a processing part.

The operation of the headlight control and that of the interior light control to be performed by the electronic control unit 10 are described below.

The operation of the headlight control is described below with reference to the flowchart of FIG. 5. In executing the headlight control, operations shown in FIG. 5 are performed every 10 msec.

At step S1, the headlight control application 21 detects whether the engine 13 has started.

The headlight control application 21 sends a request to the platform 23 to detect whether the engine 13 has started. The platform 23 actuates the engine starting API 24b to detect whether the engine 13 has started and passes a response to the headlight control application 21. When the engine 13 has started, the program goes to step S2. When the engine 13 has not started, the flowchart finishes.

At step S2, the headlight control application 21 detects whether the light switch 14 has been placed in the automatic mode.

The headlight control application 21 sends a request to the platform 23 to detect whether the light switch 14 has been placed in the automatic mode. The platform 23 actuates the light switch API 24d to detect whether the light switch 14 has been placed in the automatic mode and passes a response to the headlight control application 21. When the light switch 14 has been placed in the automatic mode, the program goes to step S3. When light switch 14 has not been placed in the automatic mode, the flowchart finishes.

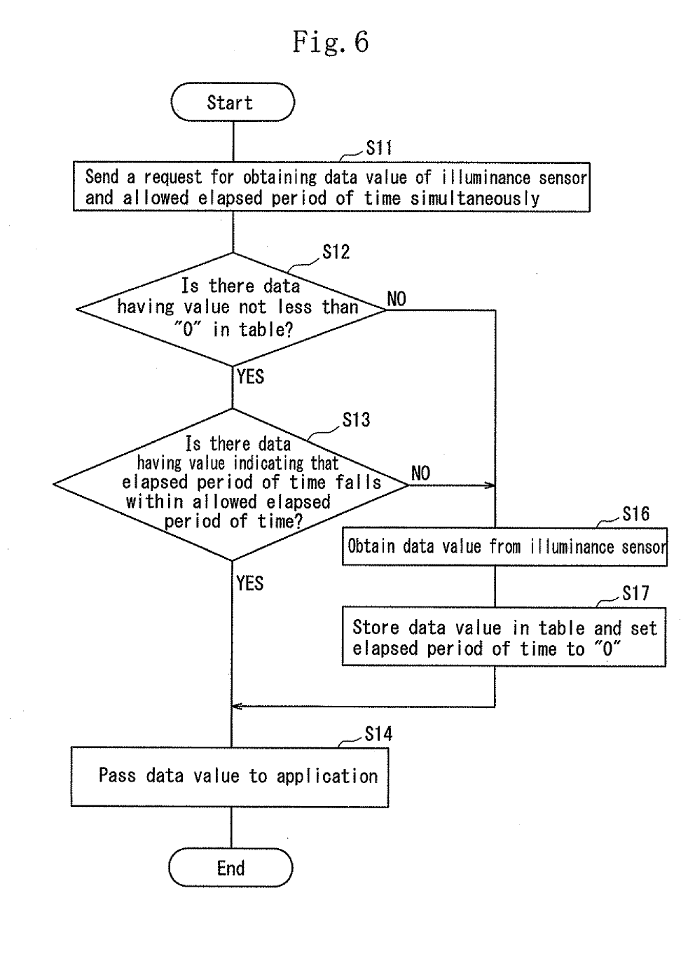

At step S3, the headlight control application 21 obtains the data value from the illuminance sensor 11. The detail is described below with reference to the flowchart of FIG. 6.

At step S11, the headlight control application 21 sends a request for obtaining the data value of the illuminance sensor 11 to the platform 23. At the same time, the headlight control application 21 sends the allowed elapsed period of time ta to the platform 23 as an argument.

For example, when a data value indicating that the elapsed period of time tb falls within 5 msec from the time when the data is obtained is desired to be used, the headlight control application 21 sends “50” to the platform 23 as the allowed elapsed period of time ta, while the table is updating the elapsed period of time tb every 0.1 msec.

At step S12, the platform 23 determines whether the elapsed period of time tb of the data value of the illuminance sensor 11 stored in the table T has a value not less than “0”. When the elapsed period of time tb of the data value thereof has a value not less than “0”, the program goes to step S13. When the elapsed period of time tb of the data value thereof is all “−1”, the program goes to step S16.

At step S13, the platform 23 compares the elapsed period of time tb of each data value with the allowed elapsed period of time ta. When data having a value indicating that the elapsed period of time tb falls within the allowed elapsed period of time ta is present, the program goes to step S14. When a data value indicating that the elapsed period of time tb falls within the allowed elapsed period of time ta is not present, the program goes to step S16.

The data value of the illuminance sensor 11 is stored in the table T not only by the operation of the headlight control application 21, but also by the operation of the interior light control application 22. The execution cycle of the headlight control and that of the interior light control are different from each other. Therefore there is a case in which the data value of the illuminance sensor 11 stored in the table T falls within the allowed elapsed period of times ta requested by a plurality of the control applications.

At step S14, the platform 23 reads a data value indicating that the elapsed period of time tb falls within the allowed elapsed period of time ta from the table T and passes the data value to the headlight control application 21.

When there is a plurality of data values indicating that the elapsed period of time tb falls within the allowed elapsed period of time ta, the platform 23 passes a data value having a shortest elapsed period of time tb to the headlight control application 21.

An operation is executed at step S16 when the platform 23 determines at step S12 that the elapsed period of time tb of the data value of the illuminance sensor 11 stored in the table T is all “−1” and when the platform 23 determines at step S13 that the data value indicating that the elapsed period of time tb falls within the allowed elapsed period of time to is not present. At step S16, the platform 23 actuates the illuminance API 24a and obtains the data value from the illuminance sensor 11.

At step S17, the data value obtained at step S16 is stored in the table T, and the elapsed period of time tb is set to “0”.

Thereafter at step S14, the platform 23 passes the stored data value to the headlight control application 21.

When the program returns to step S4 of the flowchart of FIG. 5, at step S4, the headlight control application 21 compares the data value of the illuminance sensor 11 obtained by the operation shown in FIG. 6 with a predetermined value set in advance. When the data value of the illuminance sensor 11 is smaller than the predetermined value, the program goes to step S5. When the data value of the illuminance sensor 11 is equal to or larger than the predetermined value, the program goes to step S6.

At step S5, the headlight control application 21 turns on the headlight 12. At step S6, the headlight control application 21 turns off the headlight 12.

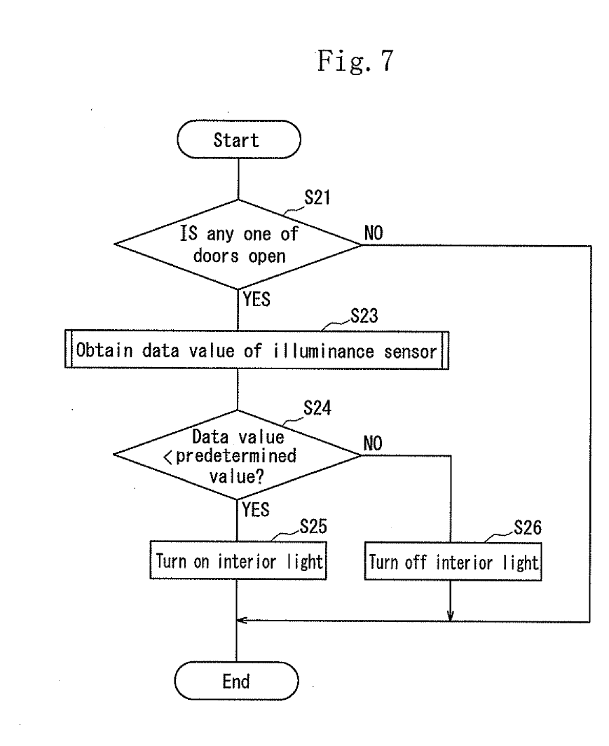

The operation of controlling the interior light is described below with reference to the flowchart of FIG. 7. In executing the headlight control, operations shown in FIG. 7 are performed every 20 msec.

At step S21, the interior light control application 22 detects whether any one of the doors of the car is open.

The interior light control application 22 sends a request for detecting whether any one of the doors of the car is open to the platform 23. The platform 23 actuates the door opening/closing API 24c to detect whether any one of the doors is open and sends a response to the interior light control application 22. When any one of the doors is open, the program goes to step S2. When all of the doors are closed, the flowchart finishes.

At step S23, by executing an operation similar to that executed as shown in flowchart of FIG. 6, the data value of the illuminance sensor 11 is obtained.

At step S24, the interior light control application 22 compares the data value of the illuminance sensor 11 with a predetermined value set in advance. When the data value of the illuminance sensor 11 is smaller than the predetermined value at step S25, the interior light control application 22 turns on the interior light 15. When the data value of the illuminance sensor 11 is equal to or larger than the predetermined value at step S26, the interior light control application 22 turns off the interior light 15.

According to the present invention, when the elapsed period of time tb from the time when the data stored in the table is obtained falls within the allowed elapsed period of time to set for each of the applications, the applications obtain data not from the illuminance sensor but from the table. Thereby the applications are capable of obtaining data at a high speed.

Further it is possible to prevent the electronic control unit 10 from accessing the illuminance sensor many times in a short period of time to obtain data and a microcomputer resource from being wastefully used.

Instead of the interior light control application 22 and the headlight control application 21, a wiper control application and an engine control application may be mounted on the electronic control unit 10.

1-4. (canceled)

5. An electronic control unit to be mounted on a car executing a plurality of applications, having different execution cycles, which are mounted on said electronic control unit by using data obtained from the same device mounted on said car,
said electronic control unit comprising:
a storing part storing data obtained from said device mounted on said car and an elapsed period of time from a time when said data is obtained; and
a processing part which compares said elapsed period of time of said data stored by said storing part with an allowed elapsed period of time from said time when said data is obtained till a time when each application is executed by using said data, thus executes each of said applications by using said data when said elapsed period of time falls within said allowed elapsed period of time and requests said device mounted on said car to send data thereto to obtain latest data when said elapsed period of time exceeds said allowed elapsed period of time,
wherein said processing part has a platform which accesses said device mounted on said car to obtain data and sends said data to said application at request of each of a plurality of said applications.

6. The electronic control unit to be mounted on a car according to claim 5, wherein said elapsed period of time stored by said storing part is updated every predetermined period of time.

7. The electronic control unit to be mounted on a car according to claim 5, wherein a plurality of said applications includes any one of a headlight control application, a car interior light control application, a wiper control application, and an engine control application.

8. The electronic control unit to be mounted on a car according to claim 6, wherein a plurality of said applications includes any one of a headlight control application, a car interior light control application, a wiper control application, and an engine control application.
